(19) United States
(12) Patent Application Publication
(10) Pub. No.: US 2018/0021819 A1
(43) Pub. Date: Jan. 25, 2018

(54) MULTI-USE PRESSURE WASHER SYSTEM

(71) Applicant: AR NORTH AMERICA, INC., Fridley, MN (US)

(72) Inventors: Mike SCHALLER, White Bear Lake, MN (US); Maureen CARROLL, Atlanta, GA (US); Jeff JUSKOWICH, Mableton, GA (US); Yi XIAGANG, Shanghai (CN); Ge XINGJUN, Shanghai (CN); Ding JUNKUI, Shanghai (CN)

(73) Assignee: AR NORTH AMERICA, INC., Fridley, MN (US)

(21) Appl. No.: 15/652,570

(22) Filed: Jul. 18, 2017

Related U.S. Application Data
(60) Provisional application No. 62/364,577, filed on Jul. 20, 2016.

(51) Int. Cl. B08B 3/02; B62B 3/04; F16M 13/02

(52) U.S. Cl. CPC B08B 3/026; F16M 13/02; B62B 3/04; B62B 2202/50

(57) ABSTRACT

A pressure-washer unit, a cart, and a fixed mount, with the pressure washer able to be mounted to the cart in a mobile (e.g., rollable) configuration and also able to be mounted to the fixed mount in a stationary (e.g., wall-mounted) configuration. In some embodiments, the pressure washer can be used in a third hand-held configuration without the cart or the fixed mount. Typical embodiments include a multi-use locating mechanism for proper positioning of the pressure washer for locking it to the cart and the fixed mount, and a multi-use coupling mechanism for locking the pressure washer on the cart and the fixed mount for use and/or storage.

### CROSS-REFERENCE TO RELATED APPLICATION

This application claims the priority benefit of U.S. Provisional Patent Application Ser. No. 62/364,577, filed Jul. 20, 2016, which is hereby incorporated herein by reference.

### TECHNICAL FIELD

The present invention relates generally to powered cleaning equipment and particularly to pressure washers for residential and commercial cleaning use.

### BACKGROUND

Pressure washers (aka power washers) are well known and commonly used for delivering a pressurized jet of fluid (e.g., water or air) to blast or ablate away deposits (e.g., dirt, paint, mold, grime, dust, and/or mud) from a surface of an object (e.g., a budding, vehicle, and/or concrete wail) to be cleaned in residential and/or commercial (non-industrial) property settings. Conventional portable/roller pressure washers are gas- or electric-powered and include wheels and a handle for easily rolling and maneuvering the pressure washer around for use in different locations. Conventional wall-mounted pressure washers are gas- or electric-powered and include mountings for securing to a wall (e.g., in a garage) in a compact and out-of-the-way location. And conventional stand-alone pressure washers are electric-powered and can be rested upon a floor in one place for use or picked up by hand and carried to another place for use. So users with a range of pressure-washing needs often end up purchasing, storing, and maintaining two or three different types of pressure washers, which tends to be expensive and inconvenient.

Accordingly, it can be seen that there exists a need for improvements in pressure washers to provide multi-use functionality. It is to the provision of solutions to this and other problems that the present invention is primarily directed.

### SUMMARY

Generally described, the present invention relates to a multi-use pressure-washer system including a pressure-washer unit, a cart, and a fixed mount. The pressure washer can be mounted to the cart in a mobile (e.g., rollable) configuration and also can be mounted to the fixed mount in a stationary (e.g., wall-mounted) configuration. In some embodiments, the pressure washer can be used in a third hand-held configuration without the cart or the fixed mount. Typical embodiments include a multi-use locating mechanism for proper positioning of the pressure washer for locking it to the cart and the fixed mount, and a multi-use coupling mechanism for locking the pressure washer on the cart and the fixed mount for use and/or storage.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a perspective view of a multi-use pressure-washer system according to a first example embodiment of the present invention, showing a pressure washer mounted to a cart in a mobile configuration, with a portion of the cart removed to better shown a coupling mechanism.

FIG. 2 is a partial-cutaway perspective detail view of a portion of a coupling mechanism of the pressure-washer system of FIG. 1 in a locked position.

FIG. 3 shows the pressure-washer system of FIG. 1 with the pressure washer positioned above and being lowered onto the cart.

FIG. 4 is another perspective view of the pressure-washer system of FIG. 1, with a locating member (and wheel) of the cart not shown to reveal a cooperating locating member of the pressure washer.

FIG. 5 is a cross-sectional view of the pressure-washer system of FIG. 4 showing the locating members for properly positioning the pressure washer and the cart for coupling together.

FIG. 6 is a perspective cross-sectional detail view of portions of the pressure-washer system of FIG. 5 showing details of the locating members.

FIG. 7 shows the pressure-washer system FIG. 3 with the pressure washer positioned on the cart and the coupling mechanism properly positioned for operation.

FIG. 8 is a partial-cutaway perspective detail view of portions of the pressure-washer system of FIG. 7 showing the coupling mechanism portion of FIG. 2 in an unlocked position.

FIG. 9 shows the pressure-washer system portion of FIG. 8 with the coupling mechanism being operated from the unlocked position to the locked position to secure the pressure washer on the cart.

FIG. 10 is an exploded perspective view of the coupling mechanism of the pressure-washer system of FIG. 1, showing the major components of the coupling mechanism disassembled for clarity.

FIG. 11 is another perspective view of the coupling mechanism of the pressure-washer system of FIG. 1, showing the major components assembled for use.

FIG. 12 is a schematic diagram of the coupling mechanism of the pressure-washer system of FIG. 1, showing its principle of operation.

FIG. 13 is a perspective view of the pressure washer of FIG. 1 shown mounted to a wall mount in a fixed configuration, with a portion of the wall mount removed to better shown a coupling mechanism.

FIG. 14 is a partial-cutaway perspective detail view of a portion of the coupling mechanism of the pressure-washer system of FIG. 13 in a locked position.

FIG. 15 is a perspective view of the wall mount of FIG. 14 shown mounted to a wall.

FIG. 16 is a right-side view of the pressure-washer system of FIG. 14, showing the pressure washer positioned away from and being moved laterally onto the wall mount.

FIG. 17 shows a front side view of the pressure-washer system of FIG. 16.

FIG. 18 is a cross-sectional detail view of a portion of the pressure-washer system of FIG. 17 taken at line 18-18, showing the locating member of the pressure washer and a cooperating locating member of the wall mount for properly positioning the pressure washer and the wall mount for coupling together.

FIG. 19 is a perspective view of the pressure-washer system FIG. 14 with the pressure washer positioned on the wall mount and the coupling mechanism properly positioned for operation.

FIG. 20 is a partial-cutaway perspective detail view of portions of the pressure-washer system of FIG. 19 showing the coupling mechanism portion of FIG. 14 in an unlocked position.

FIG. 21 shows the pressure-washer system portion of FIG. 20 with the coupling mechanism being operated from the unlocked position to the locked position to secure the pressure washer on the wall mount.

### DESCRIPTION OF EXAMPLE EMBODIMENTS

The present invention relates to a multi-use pressure washer system for residential and commercial use that can be fixedly mounted in place in a compact and out-of-the-way location for fixed use, dismounted and portably rolled easily to other locations for use, and returned and fixedly remounted in its out-of-the-way storage location. As such, it is designed as a stand-alone, versatile, and multi-mounting pressure washer providing the most fully functional pressure washer available in the residential- and commercial-use market.

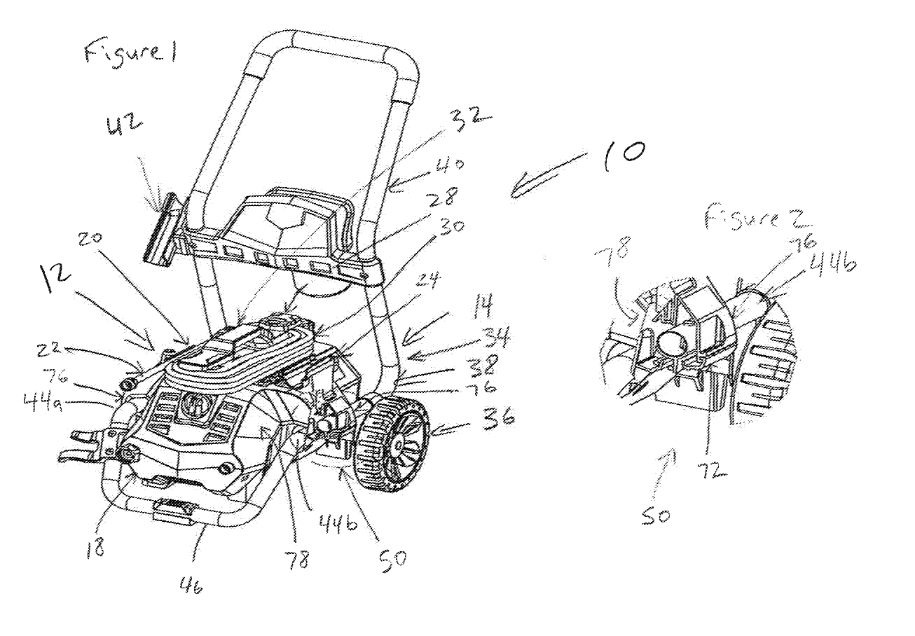

Referring to the drawings, FIGS. 1-21 show a multi-use pressure-washer system 10 according to a first example embodiment of the invention. The pressure-washer system 10 includes a pressure-washer unit 12, a cart 14, and a wall mount 16. FIGS. 1-12 show the pressure-washer unit mounted to the cart 14 in a mobile (e.g., rollable) configuration and FIGS. 13-21 show the pressure washer unit 12 mounted to the wall mount 16 in a fixed (e.g., wall-mounted) configuration. In some embodiments, in addition to the mobile configuration and the fixed configuration, the pressure-washer unit 12 can be used in a third hand-held configuration without the cart 14 or the wall mount 16.

The pressure-washer unit 12 includes conventional pressure washer components such as for example a housing 18, a motor/pump (not shown) within the housing, controls for the motor/pump (not shown), a lance holder 20 on the housing, a lance 22 mountable to the lance holder for storage, a spray gun holder 24 on the housing, a spray gun 26 mountable to the spray gun holder for storage, a power cord holder 28 on the housing, a power cord 30 electrically connected to the motor/pump and wound about the power cord holder for storage, and a handle 32 on the housing for a person to grip to move the pressure washer unit 12. The pressure-washer unit 12 can also include a turbo-nozzle for quick-connect (QC) nozzles, a foam cannon, containers for cleaners, detergents, etc., and/or features for storing any or all of these accessories. In other embodiments, the pressure washer unit includes additional or fewer conventional or new components.

The pressure-washer unit 12 is typically of an electric-powered type, though other types of pressure washers can be implemented in the system 10. In embodiments in which the pressure-washer unit 12 is of a relatively smaller and lighter-weight design (e.g., conventional electric-powered types), the pressure-washer unit can be used in a third configuration (in addition to the fixed/wall-mounted and cart-mounted configurations), specifically a standalone configuration in which it is not mounted to the cart 14 or the wall mount 16 and instead is can be easily hand-carried about by a user (i.e., as a hand unit) or rested stably on the ground for use or storage.

Referring particularly to FIGS. 1-12, the cart 14 can function as a mobile platform that securely supports the pressure-washer unit 12 in the mobile configuration to make the pressure-washer unit mobile. The cart 14 can also function as a storage platform for users who don't want the pressure-washer unit 12 to rest on the ground (including a floor or other generally horizontal support surface) while the unit is in operation or during storage. The pressure-washer unit 12 releasably attaches to the cart 14 for mobile use and can be detached from the cart for other uses such as mounting to the wall mount 16.

The cart 14 includes a frame 34 to which the pressure-washer unit 12 can be removably mounted and wheels 36 mounted to the frame. The wheels 36 can be for example conventional rubber wheels with a diameter of about 8 inches to about 11 inches. The cart frame 34 includes a base portion 38 to which the pressure-washer unit 12 is removably mounted in place and supported, and a handle portion 40 extending upward form the base portion for a user to push or pull to move the pressure-washer unit. In some embodiments, the handle portion 40 is detachable from the base portion 38 to reduce the overall size/space for compactness of the cart 14 (with or without the pressure-washer unit 12 mounted to it) for storage and packaging. And in some embodiments such as that depicted, the cart frame 34 includes a spray gun holder 42 for mounting the spray gun 26 for storage (FIGS. 1 and 5). The cart frame 34 can be made of conventional materials and configurations for example lengths of steel tubing connected together by plastic fittings.

In the depicted embodiment, the base portion 38 of the cart frame 34 includes two opposing (e.g., left and right) side members 44a and 44b (collectively, the side members 44). These side members 44 provide locations where the pressure-washer unit 12 can be removably mounted in place and supported. In this embodiment, the side members 44 are provided by steel tubing (as noted above). In other embodiments, the cart frame base can be provided by a platform, grate, or other structure, made of metal, plastic, a composite, or another material, that supports the pressure-washer unit, with the side members attached to or integrated into the frame, for example by being provided by certain surfaces of the base.

Furthermore, the base portion 38 of the cart frame 34 can include a front connecting member 46 extending laterally between and extending downward from the side members 44, and spaced forwardly from the spaced-apart wheels 36, to provide for stability of the pressure-washer unit 12 and cart 14 combination, for example as depicted. In some embodiments such as that shown, the base portion 38 of the cart frame 34 is generally U-shaped forming a center void, so that the bottom center of the pressure washer unit 12 extends below and between the spaced-apart side members 44. And the handle portion 40 of the cart frame 34 can be generally U-shaped, with the free ends of the U-shaped base and handle portions connected so that together they form a closed loop.

The pressure-washer system 10 further includes a multi-use locating mechanism 48 and a multi-use coupling mechanism 50 of the pressure-washer unit 12, the cart 14, and the wall mount 16. The multi-use coupling mechanism 50 functions to releasably secure the pressure-washer unit 12 to the cart 14 and the wall mount 16 (non-simultaneously), and the multi-use locating mechanism 48 functions to position the pressure-washer unit relative to the cart and the wall mount (non-simultaneously) for securing those selected components together. Before describing details of the multi-use locating and coupling mechanisms 48 and 50, details of the wall mount 16 will first be described.

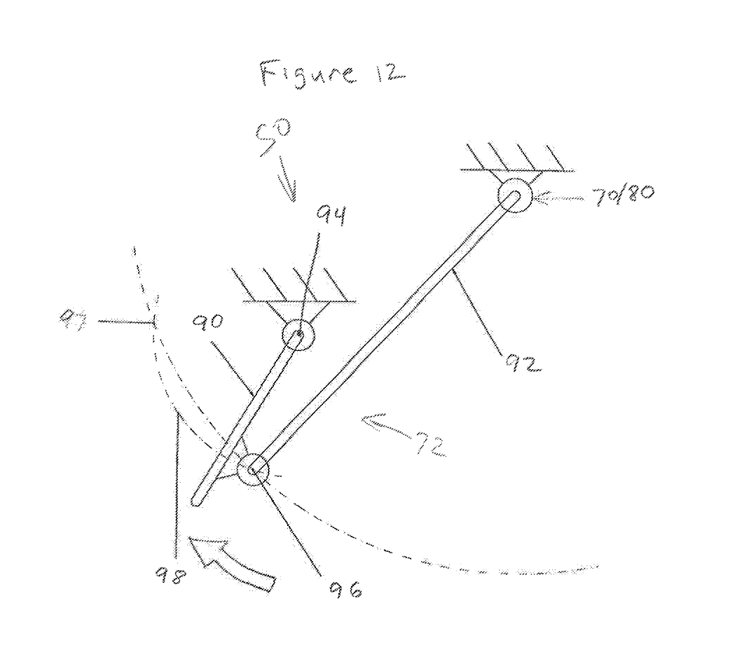

Referring particularly to FIGS. 12-21, the wall mount can be securely mounted in a fixed location for securely mounting the pressure-washer unit 12 to it in the fixed configuration. This allows a user to store the pressure washer unit 12 on the wall mount 16 in an out-of-the-way location and selectively use it from this location. Then when desired, the user can detach the pressure-washer unit 12 from the wall mount 16 for other uses such as mounting to the cart 14.

It should be noted that while the pressure-washer system 10 is described herein as including the wall mount 16 for mounting the pressure washer 12 to a wall in a fixed configuration, other mounting locations can be used (e.g., a floor, post/column, fence, roof, or board/panel). Thus, instead of the term “wall mount,” sometimes the broader term “fixed mount” is used herein. The fixed mount is intended to include the wall mount and other mounting brackets and structures adapted for mounting to such other fixed structures as may be of desirable use for locating the pressure washer unit 12 for storage and/or use.

The wall mount 16 includes a base portion 52 and two opposing (e.g., left and right) side members 54a and 54b (collectively, the side members 54). The side members 54 provide locations where the pressure-washer unit 12 can be removably mounted in place and supported. In this embodiment, the side members 54 are U-shaped and formed by plastic tubing and plastic fittings. In other embodiments, they can be in the form of bars, blocks, panels, fingers, T-shaped members, cross braces, or the like, and made of metal, composite, or other materials.

In addition, the base portion 52 includes structures (e.g., mounting holes 56 for bolts or screws) for mounting the wall mount in a fixed location. The wall-mount base 52 can be provided by a platform, peripheral-only structural members, or another structure (e.g., the depicted plastic panel), made of metal, plastic, a composite, or another material, that supports the pressure-washer unit 12, with the side members attached to or integrated into the base, for example by being provided by certain surfaces of the base.

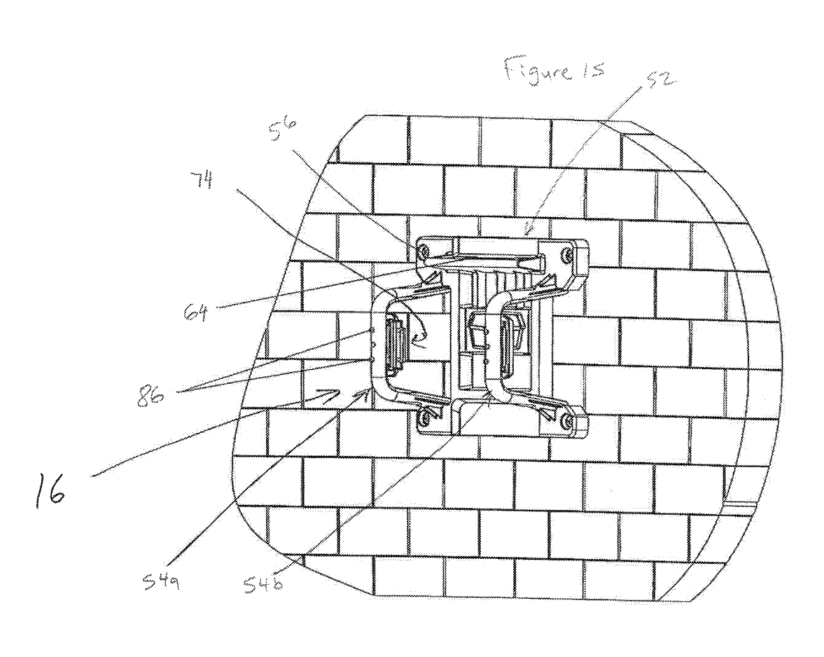

In some embodiments such as that shown, the side members 54 extend away from the base 52 and are spaced apart sufficiently that they form a center void, so that the bottom center of the pressure washer unit 12 extends below/behind and between the spaced-apart side members 54 when mounted to the wall mount 16. It will be understood that in the fixed-mount configuration mounted to a wall, the pressure-washer unit 12 is reoriented so that its top is now its front, and the wall-mount 16 is oriented so that a generally horizontal bottom surface of its base is now oriented generally vertically (and thus laterally behind the side members in the wall-mounted configuration as can be seen in FIG. 16), and these alternative descriptions are sometimes used when describing these components in the fixed-mount configuration.

Furthermore, in some embodiments the wall mount 16 include features for storing accessories for use with the pressure-washer unit 12. For example, the wall mount 16 can include features for storing a long (e.g., 25-foot) hose, a high-pressure hose, a foam cannon, and/or a detergent bottle.

Having generally described the pressure-washer unit 12, and the cart 14 and the wall mount 16 that it can be used with, details of the multi-use locating and coupling mechanisms 48 and 50 that enable this multi-use functionality will now be described. The multi-use locating mechanism 48 functions to locate the pressure-washer unit 12 relative to the cart 14 and the wall mount 16 in a proper position so that the multi-use coupling mechanism 50 can be operated to releasably secure the pressure-washer unit in place on the cart and the wall unit. That is, to ensure that mating locking components of the coupling mechanism engage each other to securely lock together, they are first (or simultaneously) fine-tune positioned relative to each other by the locating mechanism 48.

The multi-use locating mechanism 48 includes a locating element 60 of the pressure-washer unit 12 that mates with both (non-simultaneously) a locating element 62 of the cart 14 and a locating element 64 of the wall mount 16. Typically, the same surface or feature of the pressure-washer locating element 60 engages with the cart locating element 62 and the wall-mount locating element 64, and so the engaged features of the cart locating element and the wall-mount locating element have the same conforming configuration (e.g., shape and size). In other embodiments, the locating element of the pressure-washer unit can include two portions, with each one for engaging with only one of the cart and the wall mount.

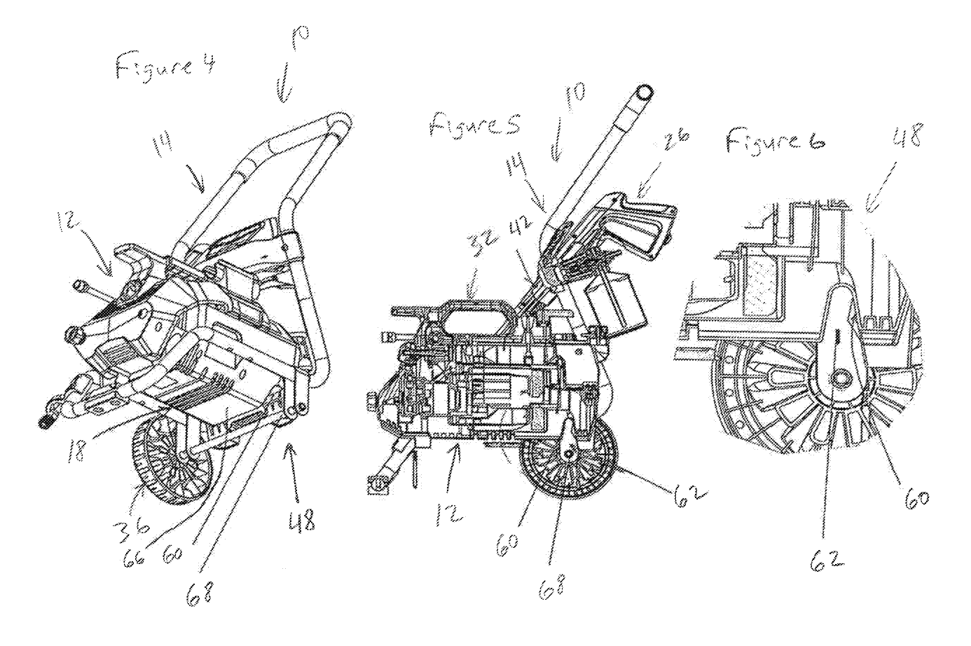

In the depicted embodiment, for example, the locating element 60 of the pressure-washer unit 12 is provided by a channel, the locating element 62 of the cart 14 is provided by a bar that is received by the pressure-washer channel (e.g., see FIGS. 4-6), and the locating element 64 of the wall mount 16 is provided by a bar that is received by the pressure-washer channel (e.g., see FIGS. 16-18). For example, the channel 60 can be formed into the bottom 66 of the pressure-washer housing 18, the cart bar 62 can extend from and be rotationally coupled to the wheel axle 68 of the cart, and the wall-mount bar 64 can extend from the base 52 of the wall mount 16 in the same direction as the side members 54, as depicted. In other embodiments, the locating element of the pressure-washer unit can be provided by a tab, finger, spike, or other protrusion, or a series or combination thereof. The bars of the cart and/or the wall mount can be provided by a slot, hole, notch, or other recess, or a series or combination thereof. And it should also be noted that the locating elements can be provided in a vice-versa arrangement, with a protrusion on the pressure-washer unit and with respective protrusion-mating recesses on the cart and wall mount.

Typically, the channel (or other recess/es) 60 and the bars (or other protrusion/s) 62/64 are tapered (e.g., in a generally conforming shape), with the recess wider at its entrance than at its deepest, and with the protrusions wider at their base than at their tip (e.g., see FIGS. 5-6 and 16 and 18). In this way, each protrusion tip is easily received into the recess entrance with extra space so that the pressure-washer unit 12 can be imprecisely/imperfectly positioned on the cart 14 or wall mount 16 in an approximate mounting position and the cooperating locking elements 60 and 62/64 will engage and automatically fine-tune the pressure washer position for locking it in place by the coupling mechanism 50. Just the channel (or other recess/es) 60 can be tapered, just the bars (or other protrusion/s) 62/64 can be tapered, or all three can be tapered in order to mechanically guide the mating elements into position for coupling together.

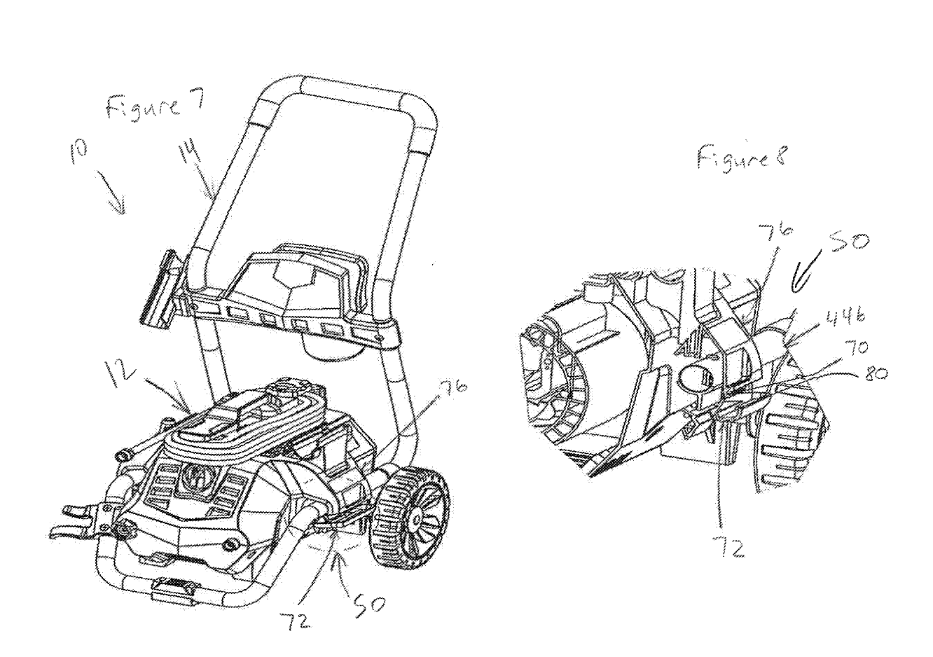

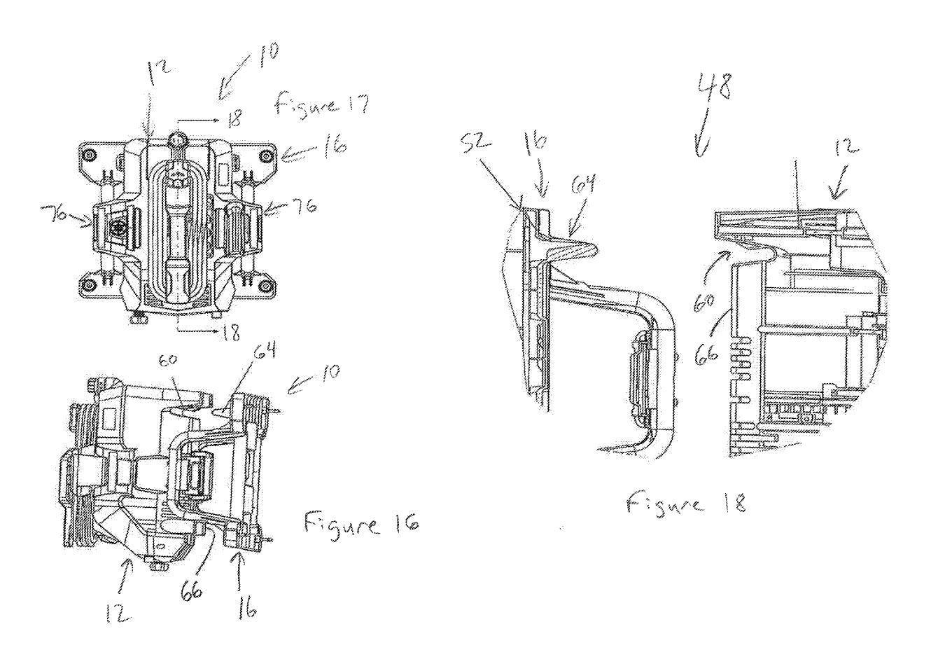

In addition, the channel (or other recess) 60 and the bar (or other protrusion) 64 are typically (but not necessarily) positioned generally horizontally (at least major portions of them are) with touching surfaces (at least major portions of them are) when the pressure-washer unit 12 is mounted to the wall mount 16 in the fixed configuration (e.g., see FIGS. 16 and 18). In this way, the abutting recess 60 and protrusion 64 of the locating mechanism 48 support (or at least help support) the weight of the pressure-washer unit 12 in place on the wall mount 16. Similarly, the recess (e.g., at its deepest) 60 and the bar (at its tip) 64 are typically (but not necessarily) positioned with touching surfaces (at least major portions of them are) when the pressure-washer unit 12 is mounted to the cart 14 in the mobile configuration (e.g., see FIG. 6) to help support the load of the pressure washer.

Turning now to the multi-use coupling mechanism 50, it enables the multi-use functionality of the pressure washer system 10, by which the pressure-washer unit 12 can be selectively mounted to the cart 14 for mobile use or mounted to the wall mount 16 for fixed-location use, and in some embodiments used as a stand-alone unit.

The multi-use coupling mechanism 50 includes at least one locking element 70 of the pressure-washer unit 12 that releasably locks to both (non-simultaneously) at least one locking element 72 of the cart 14 and at least one locking element 74 of the wall mount 16. Typically, the same surface or feature of the pressure-washer locking element 70 engages with the cart locking element 72 and the wall-mount locking element 74, and so the engaged features of the cart locking element and the wall-mount locking element have the same conforming configuration (e.g., shape and size). In other embodiments, the locking element of the pressure-washer unit can include two portions, with each one for engaging with only one of the cart and the wall mount.

For example, the multi-use coupling mechanism 50 can be a latch, clamp, clip, pin-and-aligned-holes, or other type of a conventional or unique design. Typically, the multi-use coupling mechanism 50 is of a design that functions to enable the pressure-washer unit 12 to be locked onto the cart 14 and the wall mount 16 in an automatically locking manner, without having to manually manipulate any locking element, for example by bringing into engagement the mating locking elements of the pressure washer and the cart or wall mount and by this engagement triggering operation of a spring-biased element to lock them together. Manual manipulation is then required to release the locking engagement to remove the pressure-washer unit 12 from the cart 14 or the wall mount 16. Examples of suitable automatic coupling mechanisms include spring latches, draw latches, and slam latches.

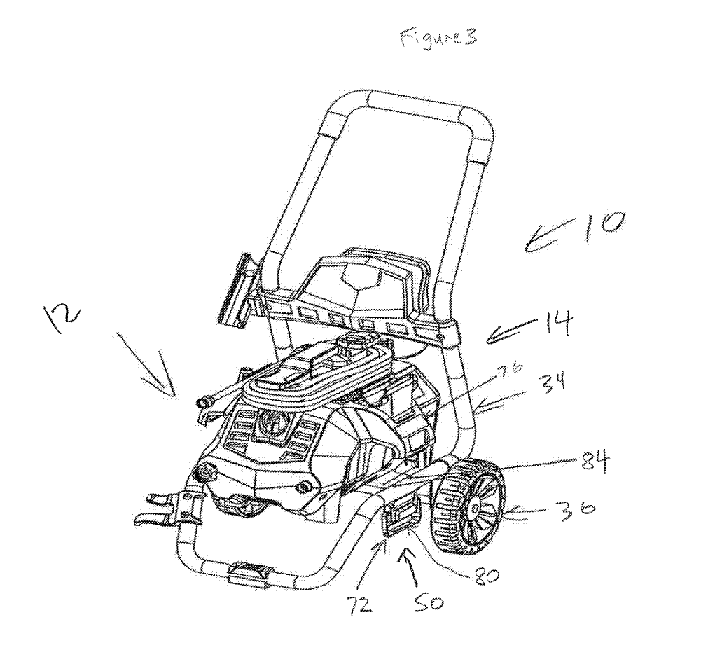

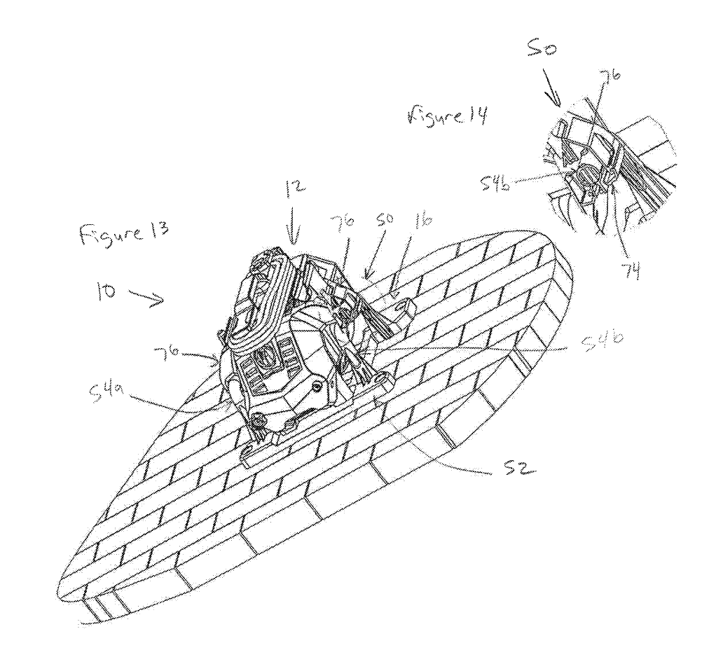

In addition, the pressure-washer unit 12 can include two arms or other support members 76 that extend laterally and oppositely from opposite sides (e.g., left and right) 78 of the pressure-washer housing 18 so that they extend over the cart side members 44 (in the mobile configuration, see, e.g., FIGS. 1-2) and in front of the wall-mount side member 54 (in the fixed configuration, see, e.g., FIGS. 13-14). Thus, the pressure-washer lateral arms 76 can include curved engagement surfaces that seat onto tubular side members 44 and 54 of the cart and wall mount. And the pressure-washer lateral arms 76 can have generally parallel lengths, with the cart and wall mount side members 44 and 54 conformingly configured, to provide stability of the pressure-washer unit 12 when mounted to the cart 14 or wall mount 16. In this way, the pressure-washer lateral arms 76 rest against the side members 44 and 54, and are supported by them (at least against the side members 44 in the mobile configuration when mounted to the cart 14).

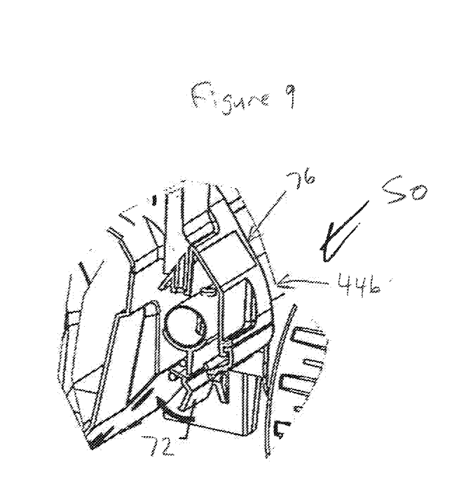

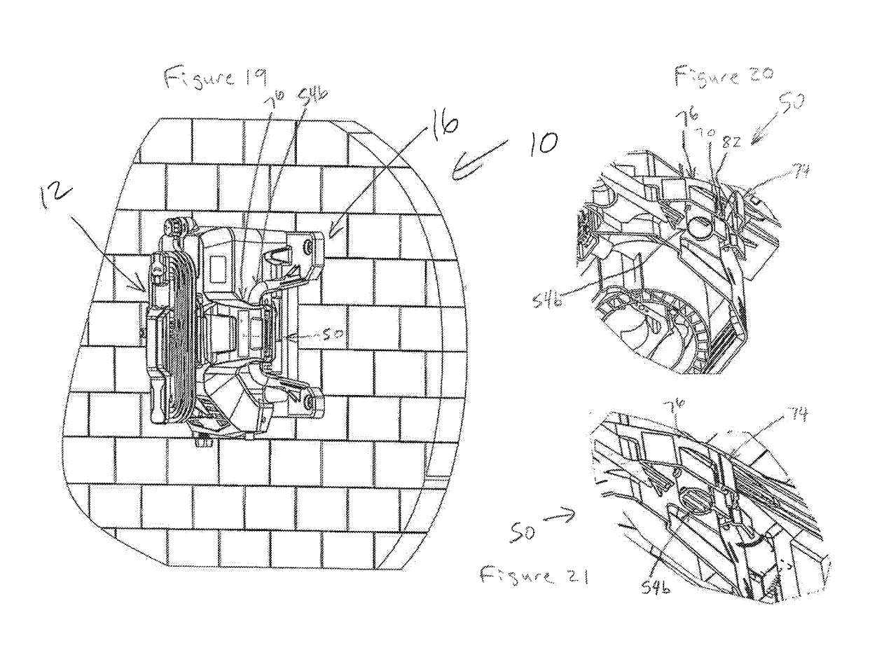

In the depicted embodiment, the multi-use coupling mechanism 50 is of a new draw-type latch design, with two locking elements 70 of the pressure-washer unit 12 provided by two catches, and with two locking elements 72 of the cart 14 provided by two clips and two locking elements 74 the wall mount 16 provided by two clips that couple to the pressure-washer catches. The two catches 70 of the pressure-washer unit 12 can be defined by the two lateral arms 76, for example they can be formed by grooves in or ledges on the lateral arms, as depicted (see, e.g., FIGS. 8 and 20). Also, the cart clips 72 can each include a hook 80 and the wall-mount clips 74 can each include a hook 82 that engage with a respective one of the pressure-washer catches 70, so that when a pivotal force is applied to the clips (as indicated by the angular arrows in FIGS. 9 and 21) the clips pivot and lock in place. The cart clips 72 can each mount to the cart 14 for example by fasteners such as screws 84 and the wall-mount clips 74 can each mount to the wall mount 16 for example by fasteners such as screws 86.

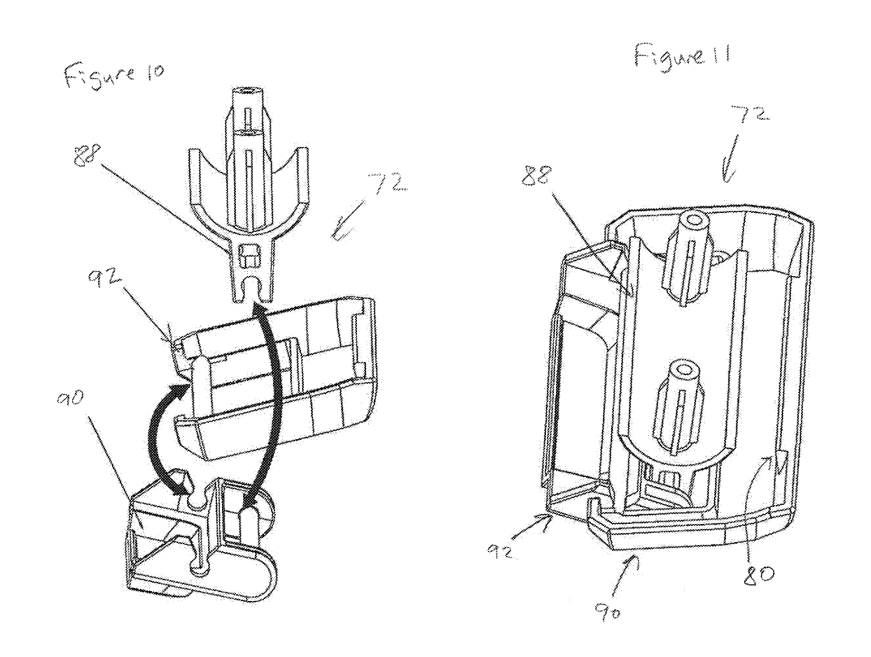

Referring to FIGS. 10-12, details of the clips 72 of the cart 14 will now be described, with FIG. 12 illustrating schematically the principle of operation of the latch coupling mechanism 50. As the wall-mount clips 74 are of the same or a similar design, this disclosure applies to them as well and will not be repeated for brevity.

The cart clips 72 each include a latch base 88 that fixedly mounts to the cart 14 (e.g., by the screws 84), a crank member 90 that is rotationally coupled to the latch base about rotational axis 94, and a connecting member 92 that rotationally coupled to the crank member about rotational axis 96. The two rotational axes 94 and 96 are spaced apart and parallel, and the crank member 90 and the connecting member 92 are both made of a resiliently deformable material such as a plastic. In operation, the crank 90 is pivoted thought its angular travel path 97 until the crank-connector rotational axis 96 intersects the travel path of the connector 92 (as shown in FIG. 12), and further pivotal motion in this angular direction results in resilient compression (shortening) of the crank member and/or resilient tensioning (lengthening) of the connecting member, until the intersection point is cleared and these parts resiliently return to their neutral unstressed state, with the clip 72 now locked in place. The coupling mechanism 50 can then be unlocked by manually pivoting the crank 90 in the opposite/reverse angular direction with sufficient force to again resiliently deform these parts until the intersection point is cleared in the opposite direction.

In other embodiments, the clip and catch elements are arranged in a vice versa configuration, with a clip on the pressure washer and catches on the cart and the wall mount. And in still other embodiments, alternative or additional support surfaces are provided on the pressure washer and the cart and wall mount for bearing some or all of the load of the pressure washer.

In yet other embodiments, the pressure-washer system includes a combination multi-use locating and coupling mechanism. In such embodiments, the pressure-washer locating component is included in the pressure-washer coupling component, the cart locating component is included in the cart coupling component, and the wall-mount locating component is included in the wall-mount coupling component. For example, mating channel and bar locating elements can be included in a latch coupling mechanism, and for example the tab can be part of a latch arm, lever, or bolt, and the slot can be formed in a latch base, backplate, or strikeplate.

And in some embodiments, the pressure-washer unit has separate coupling components for mounting to the respective coupling components of the cart and the wall mount. In such embodiments, the coupling mechanism is not a multi-use feature, as a single pressure-washer coupling component does not mate with both the cart and the wall mount, and a single pressure-washer locating component does not mate with both the cart and the wall mount.

In the embodiments described above, the pressure-washer system is designed for use at home or commercial properties (e.g., office buildings, municipal parks, and/or parking lots). In other embodiments, the pressure-washer system can be adapted for industrial use, for example by increasing the power of the motor, the strength/durability of various of the components, etc. as is understood by persons of ordinary skill in the art.

It will be noted that the three components of the pressure-washer system, the pressure-washer unit, the cart, and the fixed mount, can be provided individually or in any combination of two, for example for replacement purposes. Also, the multi-use coupling and locating mechanisms can be provided as after-market parts for retrofitting onto existing of these three components. Also, the multi-use coupling and locating mechanisms can be included in other mounting structures for supporting the pressure-washer unit in a mobile or fixed position.

Further, the multi-use coupling and locating mechanisms can be provided as after-market parts for retrofitting onto existing of these three components. And the unique latch mechanism can be provided separately for use in other devices.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A multi-use pressure-washer system, comprising:
a pressure-washer unit;
a mobile cart that has wheels for mobility and two opposing side members;
a wall mount that mounts to a wall and has and two opposing side members;
a multi-use coupling mechanism including two first locking elements of the pressure-washer unit, two second locking elements of the mobile cart, and two third locking elements of the wall mount, wherein the second locking elements and the third locking elements each engage and releasably lock to the first locking elements so that the pressure-washer unit can be selectively mounted to the mobile cart in a mobile configuration or mounted to the wall mount in a fixed configuration for stationary use, and wherein the second locking elements and the third locking elements are located on the respective side members of the cart and the wall mount; and
a multi-use locating mechanism including a first locating element of the pressure-washer unit, a second locating element of the mobile cart, and a third locating element of the wall mount, wherein the second locating element and the third locating element each engage and mate with the first locating element to position the pressure-washer unit relative to the cart and the wall mount so that the multi-use coupling mechanism can be operated to releasably secure the pressure-washer unit in place on the cart and the wall mount.

2. The multi-use pressure-washer system of claim 1, wherein the coupling mechanism is a draw latch.

3. The multi-use pressure-washer system of claim 1, wherein the pressure-washer unit includes a housing, two lateral arms extend oppositely and laterally from the housing, the two first locking elements are positioned on the two lateral arms, and the two lateral arms extend over or in front of portions of the cart in the mobile configuration and the wall mount the fixed configuration to engage with the second and third locking elements.

4. The multi-use pressure-washer system of claim 1, wherein the lateral arms of the pressure-washer unit support at least some of the load of the pressure-washer unit when mounted to the cart in the mobile configuration.

5. The multi-use pressure-washer system of claim 1, wherein the first and third locating elements of the pressure-washer unit and the wall mount support at least some of the load of the pressure-washer unit in the fixed configuration.

6. The multi-use pressure-washer system of claim 5, wherein the first and third locating elements of the pressure-washer unit and the wall mount are positioned generally horizontally with touching surfaces when the pressure-washer unit is in the fixed configuration.

7. The multi-use pressure-washer system of claim 1, wherein the first locating element of the pressure-washer unit is provided by one of a channel and a bar, and the second and third locating elements of the cart and the wall mount are provided by the other of a channel and a bar.

8. The multi-use pressure-washer system of claim 1, wherein the first locating element, or the second and third locating elements, or all three locating elements, are tapered to mechanically guide the mating locating elements into position for coupling together.

9. The multi-use pressure-washer system of claim 1, wherein the two opposing side members of the cart, the wall mount, or both define a center void that receives at least a portion of the pressure-washer in the respective mobile or fixed configuration.

10. The multi-use pressure-washer system of claim 9, wherein at least a portion of the housing of the pressure-washer unit extends below or behind the side members of the cart and the wall mount in the respective mobile and fixed configuration.

11. The multi-use pressure-washer system of claim 1, wherein the two opposing side members are generally parallel, with the cart and wall-mount side members conformingly configured, to provide stability of the pressure-washer unit when mounted to the cart or wall mount.

12. The multi-use pressure-washer system of claim 1, wherein the pressure-washer is electric powered.

13. A multi-use pressure-washer system, comprising:
a pressure-washer unit;
a mobile cart that has wheels for mobility;
a fixed mount that mounts to a fixed surface; and
a coupling mechanism including at least one first locking element of the pressure-washer unit, at least one second locking element of the mobile cart, and at least one third locking element of the fixed mount, wherein the second locking element and the third locking element each engage and releasably lock to the first locking element so that the pressure-washer unit can be selectively mounted to the mobile cart in a mobile configuration or mounted to the fixed mount in a fixed configuration for stationary use.

14. The multi-use pressure-washer system of claim 13, wherein the coupling mechanism is a draw latch.

15. The multi-use pressure-washer system of claim 13, wherein the pressure-washer unit includes a housing, at least one lateral arm extends laterally from the housing, the first locking element is positioned on the lateral arm, and the lateral arm extends over or in front of a portion of the cart in the mobile configuration and the fixed mount the fixed configuration.

16. The multi-use pressure-washer system of claim 13, wherein the cart or the fixed mount includes two opposing side members defining a center void that receives at least a portion of the pressure-washer in the respective mobile or fixed configuration.

17. The multi-use pressure-washer system of claim 13, further comprising a locating mechanism that locates the pressure-washer unit in positions relative to the cart and the fixed mount so that the multi-use coupling mechanism can be operated to releasably secure the pressure-washer unit in place on the cart and the fixed mount.

18. The multi-use pressure-washer system of claim 17, wherein the locating mechanism includes at least one first locating element of the pressure-washer unit, at least one second locating element of the mobile cart, and at least one third locating element of the fixed mount, wherein the second locating element and the third locating element each engage and mate with the first locating element.

19. The multi-use pressure-washer system of claim 18, wherein the first locating element, or the second and third locating elements, or all three locating elements, are tapered to mechanically guide the mating locating elements into position for coupling together.

20. A device selected from the group consisting of:
a pressure-washer unit including a multi-use locating and/or lock element that are/is configured to locate and interlock with multi-use locating and/or lock elements of two different mounting structures;
a cart, fixed mount, or another mounting structure including a multi-use locating and/or lock element for locating and interlocking with a multi-use locating and/or lock element of the pressure-washer unit; and
a draw latch that releasably locks together two components.
